(19) United States
(12) Patent Application Publication
(10) Pub. No.: US 2026/0057483 A1
(43) Pub. Date: Feb. 26, 2026

(54) METHOD AND APPARATUS FOR GENERATING IMAGE WITH EFFECTS, DEVICE AND STORAGE MEDIUM

(71) Applicant: Beijing Zitiao Network Technology Co., Ltd., Beijing (CN)

(72) Inventor: Chunlei RUAN, Beijing (CN)

(21) Appl. No.: 18/996,399

(22) PCT Filed: Jun. 19, 2023
(86) PCT No.: PCT/CN2023/101015

§ 371 Date: Jan. 17, 2025

(30) Foreign Application Priority Data
Jul. 18, 2022 (CN) 202210840518.0

(51) Int. Cl. G06T 5/50; G06T 7/11

(52) U.S. Cl. CPC G06T 5/50; G06T 7/11; G06T 2207/20024; G06T 2207/20221

(57) ABSTRACT

Embodiments of the disclosure provides a method and apparatus for generating an image with effects and a device and a storage medium. The method includes: determining directional distance information corresponding to an original image, wherein the directional distance information indicates grayscale information of a segmentation result of the original image or distance information between a pixel and an image segmentation boundary; generating an initial image with effects based on the directional distance information and a noise map; obtaining a target image with effects by fusing the initial image with the effects and the original image.

### CROSS-REFERENCE TO RELATED APPLICATION(S)

This application is a national stage application filed under 35 U.S. C. 371 based on International Patent Application No. PCT/CN2023/101015, filed Jun. 19, 2023, which claims the benefit of Chinese Patent Application No. 202210840518.0, filed on Jul. 18, 2022, which is are hereby incorporated by reference in their entireties.

### FIELD

The embodiment of the present disclosure relates to the technical field of image processing, for example, to a method and apparatus for generating an image with effects and a device and a storage medium.

### BACKGROUND

The intelligent terminal has become an indispensable tool in the life of the user, and the user can perform a series of entertainment activities through the intelligent terminal, for example, adding effects in the image to enhance entertainment. The addition of an edge effect (referred to as stroke edges) to the image is an image effect processing mode.

In the related art, when generating the “image stroking” effect, a linear grid or a bar-shaped mesh is constructed through the contour point, and then the stroking effect is generated based on the linear grid or the bar-shaped mesh, which may only have a single and unnatural effect.

### SUMMARY

Embodiments of the present disclosure provides a method and apparatus for generating an image with effects and a device and a storage medium, which can quickly generate an image with a “stroking” effect and having realistic effects.

In a first aspect of the present disclosure, there is provided a method for generating an image with effects is provided, including:
determining directional distance information corresponding to an original image, wherein the directional distance information indicates grayscale information of a segmentation result of the original image or distance information between a pixel and an image segmentation boundary;
generating an initial image with effects based on the directional distance information and a noise map; and
obtaining a target image with effects by fusing the initial image with the effects and the original image.

In a second aspect of the present disclosure, there is provided an apparatus for generating an image with effects, including:
a directional distance information determination module configured for determining directional distance information corresponding to an original image, wherein the directional distance information indicates grayscale information of a segmentation result of the original image or distance information between a pixel and an image segmentation boundary;
an initial image with effects generation module configured for generating an initial image with effects based on the directional distance information and a noise map; and
an target image with effects obtaining module configured for obtaining a target image with effects by fusing the initial image with the effects and the original image.

In a third aspect of the present disclosure, there is provided an electronic device, including:
one or more processors;
a storage device, configured to store one or more programs;
when the one or more programs are executed by the one or more processors, the one or more processors implement the method for generating an image with effects according to embodiments of the present disclosure.

In a fourth aspect of the present disclosure, there is provided a storage medium including computer-executable instructions, where the computer-executable instructions, when executed by a computer processor, are configured to perform the method for generating an image with effects according to embodiments of the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method for generating an image with effects according to embodiments of the present disclosure;

FIG. 2a is schematic diagram of a target object mask image according to embodiments of the present disclosure;

FIG. 2b is a schematic diagram of a dilated mask image according to embodiments of the present disclosure;

FIG. 2c is a schematic diagram of a blur mask image according to embodiments of the present disclosure;

FIG. 2d is a schematic diagram of a noise map according to embodiments of the present disclosure;

FIG. 2e is a schematic diagram of an initial image with effects according to embodiments of the present disclosure;

FIG. 3a is a schematic diagram of a first intermediate image with effects according to embodiments of the present disclosure;

FIG. 3b is a schematic diagram of a second intermediate image with effects according to embodiments of the present disclosure;

FIG. 3c is a schematic diagram of a target image with effects according to embodiments of the present disclosure;

FIG. 4 is a schematic structural diagram of an apparatus for generating an image with effects according to embodiments of the present disclosure;

FIG. 5 is a schematic structural diagram of an electronic device according to embodiments of the present disclosure.

### DETAILED DESCRIPTION

Embodiments of the present disclosure will be described in more detail below with reference to the accompanying drawings. Although some embodiments of the present disclosure are shown in the drawings, it is to be understood that the present disclosure can be realized in various forms, and these embodiments are provided for a more thorough and complete understanding of the present disclosure. It is to be understood that the drawings and embodiments of the present disclosure are only for example purposes and are not intended to limit the scope of protection of the present disclosure.

It should be understood that the steps recited in the method embodiments of the present disclosure may be performed in different orders, and/or in parallel. Further, the method embodiments may include additional steps and/or omit performing the illustrated steps.

In the description of embodiments of the present disclosure, the term “comprise(s)”and similar terms shall be understood as open inclusion, that is, “including but not limited to”. The term “based on” is to be understood as “based at least in part on”. The term “one embodiment” is to be understood as “at least one embodiment”. The term “a further embodiment” is to be understood as “at least further embodiment”. Other explicit and implicit definitions may also be comprised below.

It should be noted that concept concepts such as “first” and “second” mentioned in this disclosure are merely used to distinguish different apparatuses, modules, or units.

It should be noted that the modification of “a” and “a plurality” mentioned in this disclosure is illustrative, and those skilled in the art should understand that “one or more” should be understood unless the context clearly indicates otherwise.

The names of messages or information interaction between multiple devices in embodiments of the present disclosure are for illustrative purposes only.

It is to be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal personal information of the user. Therefore, the user can autonomously select whether to provide personal information to software or hardware executing the operation of the technical solution of the present disclosure according to the prompt information.

As an optional implementation, in response to receiving the active request of the user, the manner of sending the prompt information to the user may be, for example, a pop-up window, and the prompt prompt information may be presented in a text manner in the pop-up window. In addition, the pop-up window may further carry a selection control for the user to select “agree” or “not agree” to provide personal information to the electronic device.

It may be understood that the foregoing notification and obtaining user authorization processes are merely illustrative, and other manners of meeting related laws and regulations may also be applied to implementations of the present disclosure.

It may be understood that the data involved in the technical solution (including the data itself, the acquisition or use of the data) should follow the requirements of the corresponding laws and regulations and related regulations.

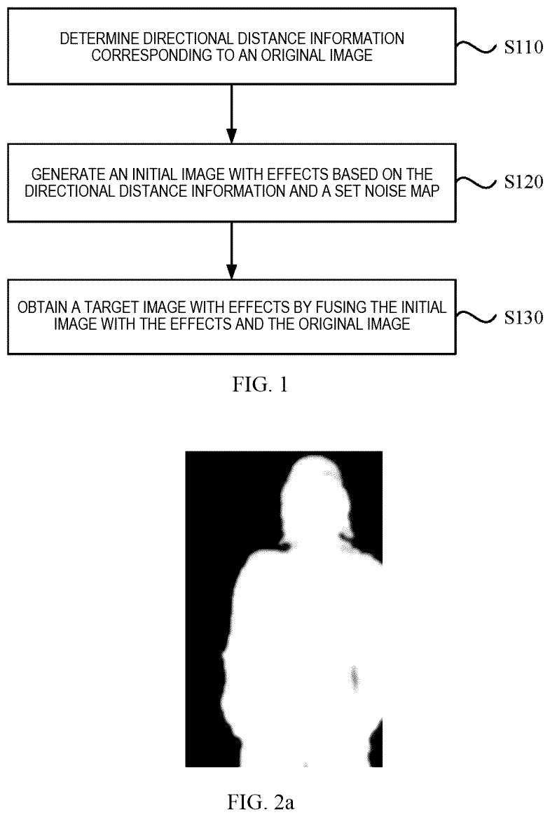

FIG. 1 is a schematic flowchart of a method for generating an image with effects according to embodiments of the present disclosure.

As shown in FIG. 1, the method comprises:

S110: Determine directional distance information corresponding to an original image.

The directional distance information indicates grayscale information of a segmentation result of the original image or distance information between a pixel and an image segmentation boundary. The segmentation result may be represented by using a segmentation mask. In this embodiment, if the directional distance information indicates the grayscale information of the segmentation result of the original image, a set linear transformation is performed on the grayscale value of the pixel in the segmentation mask image to obtain the directional distance information. If directional distance information indicates the distance information between a pixel and the image segmentation boundary, then directional distance information can be understood as the shortest distance between the pixel in the original image and the pixel on the boundary of the target area. If the pixel is within the target area, the distance can be set to negative. If the pixel is on the boundary of the target area, the distance can be set to 0. If the pixel is outside the target area, the distance can be set to positive. In this embodiment, the definition of distance values can be numerically mapped according to actual needs.

In this embodiment, the target area may be an area corresponding to the target object in the original image or an area corresponding to the entire original image. The target object may be any object such as a portrait, an animal, a plant or a building, and may be selected according to requirements.

Optionally, if the target area is an area corresponding to the target object in the original image, determining the directional distance information corresponding to the original image may be peformed by: obtaining a target object mask image by segmenting a target object in the original image; obtaining a blur mask image by blurring the target object mask image; determining the directional distance information based on the blur mask image.

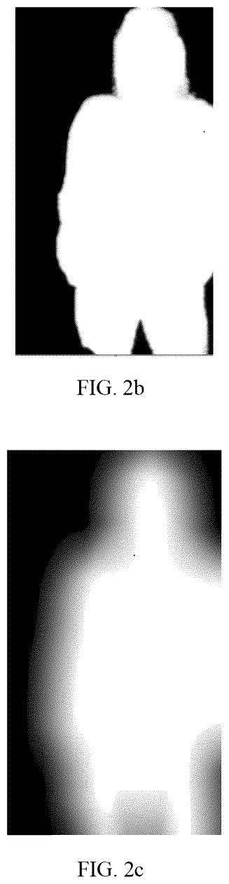

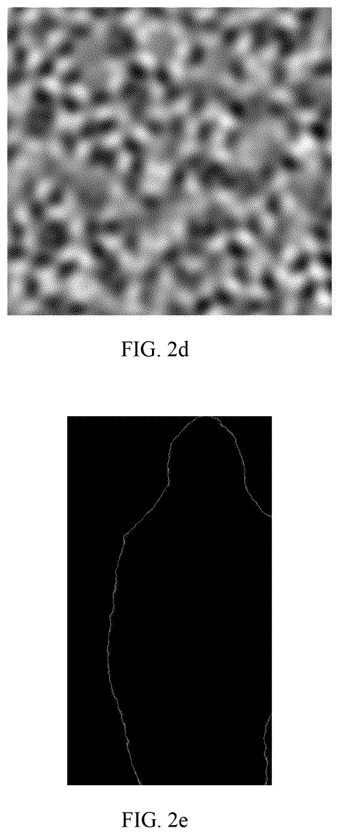

The distance information comprises a directional distance value of the pixel. In this embodiment, any matting algorithm may be used to segment the target object in the original image. For example, assuming that the target object is a portrait, as shown in FIG. 2a illustrating a schematic diagram of a target object mask image, the white region is a segmented portrait region, and the black region is a background region. One of the following methods can be used to blur the target object mask image: Gaussian blur, salt and pepper blur, or mean blur, etc. without limiting. The way to determine the directal distance information based on the blur mask image can be to determine the directal distance information based on the grayscale value of the pixel in the blur mask image. In this embodiment, the directal distance information can be accurately determined based on the blur mask image, which facilitates the generation of subsequent special effects images.

Optionally, after obtaining the target object mask image, the method further comprises obtaining a dilated mask image by dilating the target object mask image.

Image dilation can be achieved using the dilation principle in morphology. The process of image dilation processing can be understood as: traversing the pixels in the target object mask image, aligning the center of the set dilation kernel with the traversed pixels, and then taking the maximum grayscale value in the target object mask image aligned with the position where the median value of the set dilation kernel is 1, replacing the current grayscale value of the traversed pixels with the maximum grayscale value. Among them, setting the dilation kernel can be a binary matrix of a set size; A binary matrix can be understood as a matrix where the values of its elements are 0 or 1; The size can be set arbitrarily, for example, it can be 3 * 3, 5 * 5. As an example, FIG. 2b is a schematic diagram of the dilated mask image. As shown in FIG. 2b Compared with FIG. 2a, the portrait region has been dilated. Correspondingly, obtaining the blur mask image by blurring the target object mask image may be peformed by: obtaining the blur mask image by blurring the dilated mask image. In this embodiment, image dilation processing is performed on the target object mask image to prevent subsequent effects generated at the boundary of the target object from obstructing the target object.

Optionally, obtaining a blur mask image by blurring the target object mask image may be peformed by: obtaining a down-sampled mask image by performing a down-sampling operation on the target object mask image; obtaining the blur mask image by blurring the down-sampled mask image.

Downsampling the target object mask image can be understood as reducing the target object mask image. The process of downsampling can be understood as: turning the S * S window in the target object mask image into a pixel. If the size of the target object mask image is X * Y, then the size of the downsampling mask image is (x/s) * (y/s). After obtaining the downsampling mask image, Gaussian or mean blur processing is applied to the downsampling mask image to obtain a blur mask image. As an example, FIG. 2c is an example of a blur mask image, as shown in FIG. 2c. in this embodiment, the target object mask image is downsampled first, and then blurred, which can greatly reduce computational complexity and improve the efficiency of special effect image generation.

Optionally, determining the directional distance information based on the blur mask image may be peformed by: obtaining a grayscale value of a pixel in the blur mask image; obtaining the directional distance information by performing a set linear transformation on the grayscale value.

The grayscale value of the pixel in a blur mask image can be the normalized grayscale value. The way to set a linear transformation for grayscale value can be to subtract N times the grayscale value from 1. Among them, N can be a positive integer greater than or equal to 2, for example, N=2. In this embodiment, the value obtained by the set linear transformation of the grayscale value is directly used as the directal distance value of the pixel, without the need to calculate the shortest distance between the pixel and the target object boundary, which can improve the speed of determining the directional distance information.

Optionally, if the target area is the entire original image, determining the directional distance information corresponding to the original image may be peformed by: obtaining boundary information of the original image; determining the directional distance information based on the boundary information and pixel coordinates.

The boundary information of the original image may include coordinate information of four vertices of the original image boundary. In this embodiment, the rectangular coordinate system may be established by taking the center point of the circular image as the origin, the horizontal direction as the x axis and the vertical direction as the y axis. The vertex coordinates of the original image boundary and the pixel coordinates of the pixel may be determined based on the established rectangular coordinate system.

In an embodiment, the process of determining the directional distance information based on the boundary information and pixel coordinates may be peformed by: firstly, determining a coordinate difference (including a horizontal coordinate difference and a vertical coordinate difference) between the pixel coordinates and the vertex coordinates of the upper right corner of the boundary, taking the maximum value in the horizontal coordinate difference and 0 as the horizontal coordinate of the new coordinate, taking the maximum value in the vertical coordinate difference and 0 as the vertical coordinate of the new coordinate, and calculating the modulus length of the new coordinate; comparing the maximum value in the horizontal coordinate difference and the vertical coordinate difference with 0, if the maximum value is greater than 0, taking the mode length as the directional distance information, and if the maximum value is less than 0, summing the modulus length with the maximum value to obtain the directional distance information. In this embodiment, the directional distance information is determined based on the boundary information and the pixel coordinates, and the directional distance value of the pixel may be accurately and quickly determined. In addition, the entire original image is used as the target area, and the “stroking” processing of the whole image can be implemented.

S120: Generate an initial image with effects according to the directional distance information and the noise map.

The noise map may be a noise map with the same size as the original image generated by using a set noise function, the noise map may be a grayscale image, and FIG. 2d is a schematic diagram of a noise map in this embodiment.

Optionally, the process of generating the initial image with effects according to the directional distance information and the noise map may be peformed by: normalizing the directional distance information based on a set pattern; and obtaining the initial image with effects by fusing the normalized directional distance information and grayscale information of the noise map.

The process of normalizing the directional distance information based on a set pattern may be peformed by: calculating a directional distance value of the pixel based on a set pattern first; if the calculated value is between 0 and 1, retaining the value, if the value is less than 0, adjusting the value to 0, and if the value is greater than 1, adjusting the value to 1. The process of calculating the directional distance value of the pixel based on a set pattern may be peformed by: multiplyking the nth power of the directional distance value (e.g. 2nd power) by the first set value (e.g. 0.16), taking a negative value, and finally adding the negative value to the second set value (e.g. 0.15).

Optionally, the process of obtaining the initial image with effects by fusing the normalized directional distance information and grayscale information of the noise map may be peformed by: obtaining first intermediate information by linearly superposing the normalized directional distance information and the grayscale information of the noise map; obtaining second intermediate information by performing a set exponential calculation on the first intermediate information, obtaining target information by performing linear transformation on the second intermediate information and performing a set exponential calculation on the linear-transformed second intermediate information;; and generating the initial image with effects based on the target information.

The process of peobtaining first intermediate information by linearly superposing the normalized directional distance information and the grayscale information of the noise map may be peformed by: the normalized directional distance value is multiplied by the grayscale value of the pixel in the noise map, taken as negative, and then the negative value may be accumulated with the product of the first intermediate information and the set value (e.g. 0.7). Finally, the absolute value of the accumulated result is taken. A manner of performing a set exponential calculation on the first intermediate information may be peformed by: performing an exponential operation on the first intermediate information with a set value (for example, 0.13). The process of performing linear transformation on the second intermediate information may be peformed by: obtaining an initial value of the three-color channel, and performing the linear transformation on the second intermediate information based on the initial value. The process of performing a set exponential calculation on the linear-transformed second intermediate information may be peformed by: first subtracting the second intermediate information from 1, then accumulative multiplying the calculation result with the initial value of the three-color channel and the set value (for example, 1.5), and finally performing an exponential operation on the accumulative multiplication result value (for example, 4). The initial value of the three-color channel may be set according to requirements. Optionally, after the normalized directional distance information and the grayscale information of the noise map are fused, an initial image with effects may be obtained. For example, FIG. 2e is a schematic diagram of an initial image with effects in this embodiment. As shown in FIG. 2e, a highlight curve is generated at an edge of a portrait region. In this embodiment, the directional distance information and the grayscale information of the noise map are fused to generate the edge lines of the portrait with “an electro-optic effect”.

S130, Obtain a target image with effects by fusing the initial image with the effects and the original image.

The fusing of the initial image with effects and the original image may be understood as fusing the pixel values of object pixels of the original image and the initial image with effects, to obtain the target image with effects.

Optionally, the process of obtaining the target image with effects by fusing the initial image with the effects and the original image may be peformed by: performing a color filtering mode processing on the original image based on a set colormap; obtaining a first intermediate image with effects by fusing the original image and the color-filtered original image based on the blur mask image; obtaining a second intermediate image with effects by fusing the first intermediate image with effects and the initial image with effects; obtaining the target image with effects by fusing the second intermediate image with effects and the original image based on the target object mask image.

The set colormap may be a monochromatic map with a set color, that is, the color values of the pixels in the figure are the same. The process of performing a color filtering mode processing on the original image based on a set colormap may be peformed by: subtracting the color value of the set colormap from 1 to obtain a first result, subtracting the color value of the original image from 1 to obtain a second result, and finally subtracting the product of the first result and the second result from 1 to obtain the color value processed by the color filtering mode.

Optionally, the process of obtaining the first intermediate image with effects by fusing the original image and the color-filtered original image based on the blur mask image may be peformed by: determining a first fusion coefficient based on a grayscale value of the pixel in the blur mask image; obtaining the first intermediate image with effects by meriging the original image and the color-filtered original image based on the first fusion coefficient.

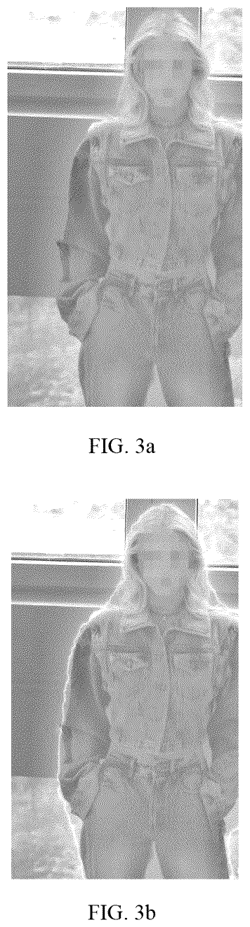

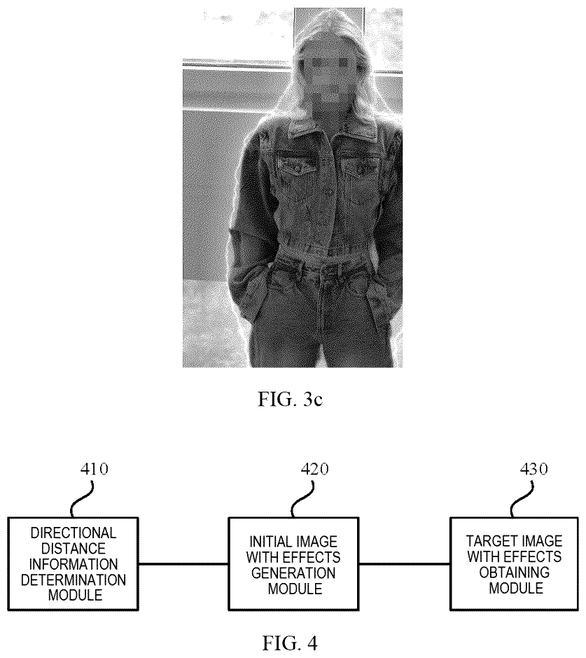

The first fusion coefficient may include a fusion coefficient corresponding to the original image and the color-filtered original image. In this embodiment, the grayscale value of the pixel in the blur mask image is the normalized value, i.e., the value between 0-1. Assuming that the grayscale value of the pixel in the blur mask image is represented as al, the first fusion coefficient corresponding to the original image is 1-a1, and the first fusion coefficient corresponding to the original image after the color filtering mode processing is a1. The process of fusing the original image and the color-filtered original image based on the first fusion coefficient may be peformed by: taking the difference between the grayscale value of the pixel in the blur mask image and the grayscale value of the pixel in the blur mask image as the weighting coefficient of the color value of the original image, and taking the grayscale value of the pixel in the blur mask image as the weighting coefficient of the color processed by the color filtering mode, to perform weighted sum on the color value of the original image and the color value processed by the color filtering mode to obtain the first intermediate image with effects. For example, FIG. 3a is a schematic diagram of a first intermediate image with effects in this embodiment, as shown in FIG. 3a, the portrait region presents a “glow”effect.

Optionally, the manner of fusing the first intermediate image with effects and the initial image with effects: accumulating color values of corresponding pixels in the first intermediate image with effects and the initial image with effects, to obtain a second intermediate image with effects. For example, FIG. 3b is a schematic diagram of a second intermediate image with effects in this embodiment.

Optionally, the manner of obtaining the target image with effects by fusing the second intermediate image with effects and the original image based on the target object mask image may be peformed by: determining a second fusion coefficient based on a grayscale value of the pixel in the target object mask image; and obtaining the target image with effects by fusing the second intermediate image with effects and the original image based on the second fusion coefficient.

The second fusion coefficient may include a fusion coefficient corresponding to the original image and the second intermediate image with effects, respectively. In this embodiment, the grayscale value of the pixel in the target object mask image is the normalized value, i.e., the value between 0-1. Assuming that the grayscale value of the target object mask image is represented as a2, the second fusion coefficient corresponding to the original image is a2, and the second fusion coefficient corresponding to the second intermediate image with effects is 1-a2. The process of fusing the second intermediate image with effects and the original image based on the second fusion coefficient may be peformed by: taking the second fusion coefficient as the weighting coefficient of the color value of the original image, taking the grayscale value of the target object mask image as the weighting coefficient of color value of the original image, and taking the difference between the 1 and the grayscale value of the target object mask image as the weighting coefficient of the color value of the second intermediate image with effects, and performing weighted sum on the color value of the original image and the color value of the second intermediate image with effects to obtain the target image. In this embodiment, the second intermediate image with effects and the original image are fused based on the target object mask image, and the portrait may be highlighted. For example, FIG. 3c is a schematic diagram of a target image with effects in this embodiment, as shown in FIG. 3c, a diagram with an “electro-optic surround”effects is generated at an edge of a portrait.

In the method of the embodiment of the present disclosure, the directional distance information corresponding to the original image is determined; an initial image with effects is generated according to the directional distance information and the noise map; and a target image with effects is obtained by fusing the initial image with effects and the original image. According to embodiments of the present disclosure provided in the method for generating an image with effects, by generating the image with effects based on the directional distance information of the original image and the noise map, the image with the set effects can be generated, which may accelerate the generation the image with effects and improve the display effect of the image with effects, and therefore the effects of special effects images are more diverse.

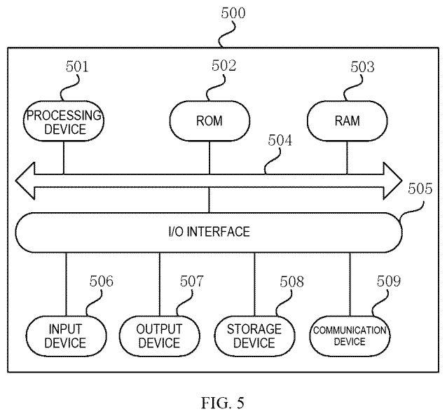

FIG. 4 is a schematic structural diagram of an apparatus for generating an image with effects according to embodiments of the present disclosure.

The directional distance information determination module 410 is configured for determining directional distance information corresponding to an original image, wherein the directional distance information indicates grayscale information of a segmentation result of the original image or distance information between a pixel and an image segmentation boundary.

The initial image with effects generation module 420 is configured for generating an initial image with effects based on the directional distance information and a noise map.

The target image with effects obtaining module 430 is configured for obtaining a target image with effects by fusing the initial image with the effects and the original image.

Optionally, the directional distance information determination module 410 is configured to determine the directional distance information corresponding to the original image in the following manner:
obtaining a target object mask image by segmenting a target object in the original image;
obtaining a blur mask image by blurring the target object mask image;
determining the directional distance information based on the blur mask image, wherein the distance information comprises a directional distance value of a pixel.

Optionally, the apparatus further comprises an dilation processing module, configured to:
obtaining a dilated mask image by dilating the target object mask image;
wherein the obtaining the blur mask image by blurring the target object mask image comprises:
obtaining the blur mask image by blurring the dilated mask image.

Optionally, the directional distance information determination module 410 is configured to obtain the blur mask image by blurring the target object mask image in the following manner.
obtaining a down-sampled mask image by performing a down-sampling operation on the target object mask image;
obtaining the blur mask image by blurring the down-sampled mask image.

Optionally, the directional distance information determination module 410 is configured to determine the directional distance information based on the blur mask image in the following manner:
obtaining a grayscale value of a pixel in the blur mask image;
obtaining the directional distance information by performing a set linear transformation on the grayscale value.

Optionally, the directional distance information determination module 410 is configured to determine the directional distance information corresponding to the original image in the following manner:
obtaining boundary information of the original image;
determining the directional distance information based on the boundary information and pixel coordinates.

Optionally, the initial image with effects generation module 420 is configured to generate the initial image with effects based on the directional distance information and a noise map in the following manner:
normalizing the directional distance information based on a set pattern;
obtaining the initial image with effects by fusing the normalized directional distance information and grayscale information of the noise map.

Optionally, the initial image with effects generation module 420 is configured to obtain the initial image with effects by fusing the normalized directional distance information and the grayscale information of the noise map in the following manner:
obtaining first intermediate information by superposing the normalized directional distance information and the grayscale information of the noise map;
obtaining second intermediate information by performing a set exponential calculation on the first intermediate information;
obtaining target information by performing linear transformation on the second intermediate information and performing a set exponential calculation on the linear-transformed second intermediate information;
generating the initial image with effects based on the target information.

Optionally, the target image with effects obtaining module 430 is configured to obtain the target image with effects by fusing the initial image with the effects and the original image in the following manner:
performing a color filtering mode processing on the original image based on a set colormap;
obtaining a first intermediate image with effects by fusing the original image and the color-filtered original image based on the blur mask image;
obtaining a second intermediate image with effects by fusing the first intermediate image with effects and the initial image with effects;
obtaining the target image with effects by fusing the second intermediate image with effects and the original image based on the target object mask image.

Optionally, the target image with effects obtaining module 430 is configured to obtain the first intermediate image with effects by fusing the original image and the color-filtered original image based on the blur mask image in the following manner:
determining a first fusion coefficient based on a grayscale value of the pixel in the blur mask image;
obtaining the first intermediate image with effects by fusing the original image and the color-filtered original image based on the first fusion coefficient.

Optionally, the target image with effects obtaining module 430 is configured to obtain the target image with effects by fusing the second intermediate image with effects and the original image based on the target object mask image in the following manner:
determining a second fusion coefficient based on a grayscale value of the pixel in the target object mask image;
obtaining the target image with effects by fusing the second intermediate image with effects and the original image based on the second fusion coefficient.

The apparatus for generating an image with effects provided by the embodiments of the present disclosure may perform the method for generating an image with effects provided by any embodiment of the present disclosure, and has functional modules and beneficial effects corresponding to the execution method.

It is worth noting that the various units and modules included in the above device are only divided according to functional logic, and the actual division only needs to be able to achieve the corresponding functions; In addition, the names of each functional unit are only for the purpose of distinguishing them from each other.

FIG. 5 is a schematic structural diagram of an electronic device according to embodiments of the present disclosure. FIG. 5 is a schematic structural diagram of an electronic device (such as the terminal device or server in FIG. 5) suitable for implementing the embodiments of the present disclosure. The terminal device in the embodiments of the present disclosure may include a mobile phone, a notebook computer, a digital broadcast receiver, a personal digital assistant (PDA), a tablet computer (PAD), a portable multimedia player (PMP), a vehicle-mounted terminal (for example, an in-vehicle navigation terminal), and the like, and a fixed terminal such as a digital television (TV), a desktop computer, or the like. The electronic device shown in FIG. 5 is merely an example.

As shown in FIG. 5, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. While FIG. 5 shows an electronic device 500 having various devices, it should be understood that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions in the method according to the embodiments of the present disclosure are performed.

The names of messages or information interaction between multiple devices in embodiments of the present disclosure are for illustrative purposes only.

The electronic device provided in this disclosed embodiment and the method for generating the special effects provided in the above embodiment belong to the same inventive concept. Technical details not described in detail in this embodiment can be found in the above embodiment, and this embodiment has the same beneficial effect as the above embodiment.

Embodiments of the present disclosure provide a computer storage medium. The medium stores a computer program thereon which, when executed by a processor, implements the method for generating an image with effects provided in the foregoing embodiments is implemented.

It should be noted that the computer-readable medium described above may be a computer readable signal medium, a computer readable storage medium, or any combination of the foregoing two. The computer-readable storage medium may be, for example, an electrical, magnetic, optical, electromagnetic, infrared, or semiconductor system, device, or device, or any combination thereof. The computer-readable storage medium may include: an electrical connection having one or more wires, a portable computer diskette, a hard disk, a RAM, a ROM, an erasable programmable read-only memory (EPROM or Flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms, including electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including wires, optical cables, Radio Frequency (RF), and the like, or any suitable combination thereof.

In some implementations, the client, server may communicate using any currently known or future developed network protocol, such as HyperText Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to: determine directional distance information corresponding to an original image, wherein the directional distance information indicates grayscale information of a segmentation result of the original image or distance information of a pixel and an image segmentation boundary; generate an initial image with effects according to the directional distance information and a noise map; and fuse the initial image with effects and the original image to obtain a target image with effects.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In some cases, the name of the unit may be set according to an actual situation, for example, the first obtaining unit may be further described as “unit for obtaining at least two Internet Protocol addresses”.

The functions described above may be performed, at least in part, by one or more hardware logic components. For example, the exemplary types of hardware logic components that may be used include: a Field Programmable Gate Array (FPGA), an Application Specific Integrated Circuit (ASIC), an Application Specific Standard (ASSP), a System on Chip (SOC), a Complex Programming Logic Device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, devices, or devices, or any suitable combination of the foregoing. The machine-readable storage medium may include an electrical connection based on one or more lines, a portable computer disk, a hard disk, a RAM, a ROM, an erasable programmable read-only memory (EPROM or Flash memory), an optical fiber, a CD-ROM, an optical storage device, a magnetic storage device, or any suitable combination of the foregoing.

According to one or more embodiments of the present disclosure, there is provided a method for generating an image with effects, including:
determining directional distance information corresponding to an original image, wherein the directional distance information indicates grayscale information of a segmentation result of the original image or distance information between a pixel and an image segmentation boundary;
generating an initial image with effects based on the directional distance information and a noise map;
obtaining a target image with effects by fusing the initial image with the effects and the original image.

Optionally, determining the directional distance information corresponding to the original image comprises:
obtaining a target object mask image by segmenting a target object in the original image;
obtaining a blur mask image by blurring the target object mask image;
determining the directional distance information based on the blur mask image, wherein the distance information comprises a directional distance value of a pixel.

Optionally, after obtaining the target object mask image, the method further comprises:
obtaining a dilated mask image by dilating the target object mask image;
the obtaining the blur mask image by blurring the target object mask image comprises:
obtaining the blur mask image by blurring the dilated mask image.

Optionally, obtaining the blur mask image by blurring the target object mask image comprises:
obtaining a down-sampled mask image by performing a down-sampling operation on the target object mask image;
obtaining the blur mask image by blurring the down-sampled mask image.

Optionally, determining the directional distance information based on the blur mask image comprises:
obtaining a grayscale value of a pixel in the blur mask image;
obtaining the directional distance information by performing a set linear transformation on the grayscale value.

Optionally, determining the directional distance information corresponding to the original image comprises:
obtaining boundary information of the original image;
determining the directional distance information based on the boundary information and pixel coordinates.

Optionally, generating the initial image with effects based on the directional distance information and a noise map comprises:
normalizing the directional distance information based on a set pattern;
obtaining the initial image with effects by fusing the normalized directional distance information and grayscale information of the noise map.

Optionally, obtaining the initial image with effects by fusing the normalized directional distance information and the grayscale information of the noise map comprises:
obtaining first intermediate information by superposing the normalized directional distance information and the grayscale information of the noise map;
obtaining second intermediate information by performing a set exponential calculation on the first intermediate information;
obtaining target information by performing linear transformation on the second intermediate information and performing a set exponential calculation on the linear-transformed second intermediate information;
generating the initial image with effects based on the target information.

Optionally, obtaining the target image with effects by fusing the initial image with the effects and the original image comprises:
performing a color filtering mode processing on the original image based on a set colormap;
obtaining a first intermediate image with effects by fusing the original image and the color-filtered original image based on the blur mask image;
obtaining a second intermediate image with effects by fusing the first intermediate image with effects and the initial image with effects;
obtaining the target image with effects by fusing the second intermediate image with effects and the original image based on the target object mask image.

Optionally, obtaining the first intermediate image with effects by fusing the original image and the color-filtered original image based on the blur mask image comprises:
determining a first fusion coefficient based on a grayscale value of the pixel in the blur mask image;
obtaining the first intermediate image with effects by fusing the original image and the color-filtered original image based on the first fusion coefficient.

Optionally, obtaining the target image with effects by fusing the second intermediate image with effects and the original image based on the target object mask image comprises:
determining a second fusion coefficient based on a grayscale value of the pixel in the target object mask image;
obtaining the target image with effects by fusing the second intermediate image with effects and the original image based on the second fusion coefficient.

Further, while operations are depicted in a particular order, this should not be understood to require that these operations be performed in the particular order shown or in sequential order. In certain circumstances, multitasking and parallel processing may be advantageous. Certain features described in the context of separate embodiments may also be implemented in combination in a single embodiment. Conversely, the various features described in the context of a single embodiment may also be implemented in multiple embodiments either individually or in any suitable sub-combination.

1. A method for generating an image with effects comprising:
determining directional distance information corresponding to an original image, wherein the directional distance information indicates grayscale information of a segmentation result of the original image or distance information between a pixel and an image segmentation boundary;
generating an initial image with effects based on the directional distance information and a noise map; and
obtaining a target image with effects by fusing the initial image with the effects and the original image.

2. The method of claim 1, wherein determining the directional distance information corresponding to the original image comprises:
obtaining a target object mask image by segmenting a target object in the original image;
obtaining a blur mask image by blurring the target object mask image; and
determining the directional distance information based on the blur mask image, wherein the distance information comprises a directional distance value of a pixel.

3. The method of claim 2, wherein after obtaining the target object mask image, the method further comprises:
obtaining a dilated mask image by dilating the target object mask image; and
wherein the obtaining the blur mask image by blurring the target object mask image comprises:
obtaining the blur mask image by blurring the dilated mask image.

4. The method of claim 2, wherein obtaining the blur mask image by blurring the target object mask image comprises:
obtaining a down-sampled mask image by performing a down-sampling operation on the target object mask image; and
obtaining the blur mask image by blurring the down-sampled mask image.

5. The method of claim 2, wherein the determining the directional distance information based on the blur mask image comprises:
obtaining a grayscale value of a pixel in the blur mask image; and
obtaining the directional distance information by performing a set linear transformation on the grayscale value.

6. The method of claim 1, wherein determining the directional distance information corresponding to the original image comprises:
obtaining boundary information of the original image; and
determining the directional distance information based on the boundary information and pixel coordinates.

7. The method of claim 1, wherein the generating the initial image with effects based on the directional distance information and the noise map comprises:
normalizing the directional distance information based on a set pattern to obtain normalized directional distance information; and
obtaining the initial image with effects by fusing the normalized directional distance information and grayscale information of the noise map.

8. The method of claim 7, wherein the obtaining the initial image with effects by fusing the normalized directional distance information and the grayscale information of the noise map comprises:
obtaining first intermediate information by superposing the normalized directional distance information and the grayscale information of the noise map;
obtaining second intermediate information by performing a first set exponential calculation on the first intermediate information;
obtaining target information by performing linear transformation on the second intermediate information to obtain linear-transformed second intermediate information and performing a second set exponential calculation on the linear-transformed second intermediate information; and
generating the initial image with effects based on the target information.

9. The method of claim 2, wherein the obtaining the target image with effects by fusing the initial image with the effects and the original image comprises:
performing a color filtering mode processing on the original image based on a set colormap to obtain a color-filtered original image;
obtaining a first intermediate image with effects by fusing the original image and the color-filtered original image based on the blur mask image;
obtaining a second intermediate image with effects by fusing the first intermediate image with effects and the initial image with effects; and
obtaining the target image with effects by fusing the second intermediate image with effects and the original image based on the target object mask image.

10. The method of claim 9, wherein the obtaining the first intermediate image with effects by fusing the original image and the color-filtered original image based on the blur mask image comprises:
determining a first fusion coefficient based on a grayscale value of the pixel in the blur mask image; and
obtaining the first intermediate image with effects by fusing the original image and the color-filtered original image based on the first fusion coefficient.

11. The method of claim 9, wherein the obtaining the target image with effects by fusing the second intermediate image with effects and the original image based on the target object mask image comprises:
determining a second fusion coefficient based on a grayscale value of the pixel in the target object mask image; and
obtaining the target image with effects by fusing the second intermediate image with effects and the original image based on the second fusion coefficient.

12. (canceled)

13. An electronic device, comprising:
one or more processors;
a storage device, configured to store one or more programs;
when the one or more programs are executed by the one or more processors, the one or more processors implement a method comprising:
determining directional distance information corresponding to an original image, wherein the directional distance information indicates grayscale information of a segmentation result of the original image or distance information between a pixel and an image segmentation boundary;
generating an initial image with effects based on the directional distance information and a noise map; and
obtaining a target image with effects by fusing the initial image with the effects and the original image.

14. A non-transitory storage medium comprising computer-executable instructions, wherein the computer-executable instructions, when executed by a computer processor, are configured to perform a method comprising:
determining directional distance information corresponding to an original image, wherein the directional distance information indicates grayscale information of a segmentation result of the original image or distance information between a pixel and an image segmentation boundary;
generating an initial image with effects based on the directional distance information and a noise map; and
obtaining a target image with effects by fusing the initial image with the effects and the original image.

15. The device of claim 13, wherein determining the directional distance information corresponding to the original image comprises:
obtaining a target object mask image by segmenting a target object in the original image;
obtaining a blur mask image by blurring the target object mask image; and
determining the directional distance information based on the blur mask image, wherein the distance information comprises a directional distance value of a pixel.

16. The device of claim 15, wherein after obtaining the target object mask image, the method further comprises:
obtaining a dilated mask image by dilating the target object mask image; and
wherein the obtaining the blur mask image by blurring the target object mask image comprises:
obtaining the blur mask image by blurring the dilated mask image.

17. The device of claim 15, wherein obtaining the blur mask image by blurring the target object mask image comprises:
obtaining a down-sampled mask image by performing a down-sampling operation on the target object mask image; and
obtaining the blur mask image by blurring the down-sampled mask image.

18. The device of claim 15, wherein the determining the directional distance information based on the blur mask image comprises:
obtaining a grayscale value of a pixel in the blur mask image; and
obtaining the directional distance information by performing a set linear transformation on the grayscale value.

19. The device of claim 13, wherein determining the directional distance information corresponding to the original image comprises:
obtaining boundary information of the original image; and
determining the directional distance information based on the boundary information and pixel coordinates.

20. The device of claim 13, wherein the generating the initial image with effects based on the directional distance information and the noise map comprises:
normalizing the directional distance information based on a set pattern to obtain normalized directional distance information; and
obtaining the initial image with effects by fusing the normalized directional distance information and grayscale information of the noise map.

21. The device of claim 20, wherein the obtaining the initial image with effects by fusing the normalized directional distance information and the grayscale information of the noise map comprises:
obtaining first intermediate information by superposing the normalized directional distance information and the grayscale information of the noise map;
obtaining second intermediate information by performing a first set exponential calculation on the first intermediate information;
obtaining target information by performing linear transformation on the second intermediate information to obtain linear-transformed second intermediate information and performing a second set exponential calculation on the linear-transformed second intermediate information; and
generating the initial image with effects based on the target information.
